(19) United States
(12) Patent Application Publication
(10) Pub. No.: US 2007/0064625 A1
(43) Pub. Date: Mar. 22, 2007

(54) Method of processing emergent data in wireless sensor network

(75) Inventors: Hun Lim, Seoul (KR); Kyung-soo Lim, Seoul (KR); Kyu-ho Han, Seoul (KR); Sun-shin An, Seoul (KR); Won-keun Kong, Suwon-si (KR); Su-myeon Kim, Suwon-si (KR); Kyle Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/442,386

(22) Filed: May 30, 2006

(30) Foreign Application Priority Data
Sep. 21, 2005 (KR) 2005-87704

(51) Int. Cl. H04L 12/28; H04L 12/56

(52) U.S. Cl. 370/254; 370/400

(57) ABSTRACT

A method of processing emergent data in a wireless sensor network is provided in which the latest information is collected from each sensor node and stored, newly-received sensing data are determined as emergent data if an error is over a certain value compared to the latest information from each node, and the emergent data are added with average data of neighbor nodes and transmitted to a sink node. Accordingly, whether neighbor sensor nodes are normal in a wireless sensor network can be determined and managed. An intermediate node can process emergent data generated from each sensor node and separate data by a sensor malfunction or urgent data so that a malfunction of each sensor node can be easily determined and reliability of sensing data of each sensor node can be improved.

### CROSS-REFERENCE TO RELATED APPLICATIONS

This application claims the benefit under 35 U.S.C. § 119(a) of Korean Patent Application No. 2005-87704, filed Sep. 21, 2005 in the Korean Intellectual Property Office, the entire disclosure of which is hereby incorporated by reference.

### BACKGROUND OF THE INVENTION

1. Field of the Invention

The present invention relates to a method of processing emergent data in a wireless sensor network. More particularly, the present invention relates to a method of processing emergent data in a wireless sensor network in which latest information is collected from each sensor node and stored, newly-received sensing data are determined as emergent data if an error is over a certain value that is compared to the latest information from each node, and the emergent data are added with average data of neighbor nodes and transmitted to a sink node.

2. Description of the Related Art

Generally in a wireless sensor network, a cluster-based hierarchical routing method has more advantages than a plane structure routing method. The cluster-based hierarchical routing method is a method in which a wireless sensor network is divided into plural regions of cluster units and a cluster is classified into cluster heads 102˜108, a sink node 110, and sensor nodes 112˜124, according to their roles as shown in FIG. 1. The hierarchical routing method performs routing by a relay node and the sink node, except the plural sensor nodes, so that a wireless sensor network can be consumed efficiently in power.

The sink node 110, also called an access node, functions as a receiver in a wireless sensor network and is a destination node where certain data are transmitted. The sensor node 112˜124 functions as a transmitter and is a source node of certain data to transmit to the sink node 110. A cluster head 102˜108, also called a relay node, constructs a data transmission route from the sensor node 112˜124 to the sink node 110.

Meanwhile, a sensor node located within a certain distance from the sink node 110, transmits transmission data directly to the sink node 110. However, the sensor nodes 112˜124, which are not located within the certain distance from the sink node 110, do not directly transmit collected data to the sink node 110 but transmits the data through the relay nodes 102˜108 adjacent to the sink node 110. Accordingly, power consumption according to data transmission is minimized. That is, the distance between the sink node 110 and the sensor node 112˜124 is generally proportional to power consumption to transmit data from the sensor node 112˜124 to the sink node 110.

Therefore, the sensor nodes 112˜124 which are not located within the certain distance from the sink node 110 transmit the data through the plural relay nodes 102˜108 so that power consumption according to data transmission gets minimized. In addition, the sink node 110 is not fixed but movable to some extent.

When each relay node 102˜108 transmits data to the sink node 110, the relay node 102˜108 aggregates data received from the sensor nodes 112˜124 to transmit to the sink node 110. Accordingly, when data collected from each sensor node 112˜124 to transmit to the sink node 110 include emergent data, which are generated by a sensor node malfunction, and have an unusual numerical value or are over a preset threshold, the sink node 110 receives the aggregated data including the emergent data. As a result, it is difficult for the emergent data to separate from the received data to compare and analyze with different data.

Additionally, each sensor node 112˜124 has a threshold. Whenever sensing data are generated, the sensing data are compared to the threshold to determine whether to be emergent data, and transmitted to the relay nodes 102˜108. However, as the emergent data may be generated by a sensor malfunction, reliability on the sensing data can not be guaranteed. In addition, the sensing data are aggregated in the relay nodes 102˜108 so that it is difficult to determine which sensor node is malfunctioning.

Accordingly, there is a need for an improved method of processing emergent data in a wireless sensor network by determining a malfunction of sensor nodes.

### SUMMARY OF THE INVENTION

An aspect of exemplary embodiments of the present invention is to solve at least the above problems and/or disadvantages and to provide at least the advantages described below. Accordingly, an aspect of exemplary embodiments of the present invention is to provide a method of processing emergent data in a wireless sensor network in which latest information is collected from each sensor node and stored, newly-received sensing data are determined as emergent data, if an error is over a certain value that is compared to the latest information from each node, and the emergent data are added with average data of neighbor nodes and transmitted to a sink node.

In order to achieve the above-described aspects of the present invention, there is provided a method of processing emergent data in a wireless sensor network, in which latest data from sensor nodes are collected and stored, sensing data from a certain sensor node are received, the sensing data to the latest data are compared, and the sensing data are processed into emergent data if an error between the sensing data and the latest data is over a certain error range.

Additionally, the comparing of the sensing data is performed to check if neighbor sensor nodes are normal. The emergent data are first transmitted as urgent data to a sink node in the processing of the sensing data.

Further, sensing data received from the sensor nodes except the emergent data are aggregated and transmitted to the sink node in the processing of the sensing data. The emergent data includes urgent data or error data.

Meanwhile, the aspects of exemplary embodiments of the present invention is also achieved by a method of processing emergent data in a wireless sensor network in which first sensing data from a sensor node are received where emergent data over a threshold are generated, second sensing data are received from plural sensor nodes, the first sensing data are compared to the second sensing data, the first sensing data are recognized as the emergent data if an error between the first sensing data and the second sensing data is over a certain error range, average data of the plural sensor nodes are added to the emergent data, and the added data are transmitted to a sink node.

Additionally, the recognizing of the first sensing data is performed in an emergency such as intrusion and a fire, and is also performed when the first sensing data need is compared to state data of the plural sensor nodes. The emergent data includes urgent data or error data.

Other objects, advantages, salient features of the invention will become apparent to those skilled in the art from the following detailed description, which, taken in conjunction with the annexed drawings, discloses exemplary embodiments of the invention.

### BRIEF DESCRIPTION OF THE DRAWING

The above and other objects, features, and advantages of certain exemplary embodiments of the present invention will be more apparent from the following description taken in conjunction with the accompanying drawings, in which:

FIG. 1 is a schematic view showing the configuration of a wireless sensor network of a conventional hierarchical routing method;

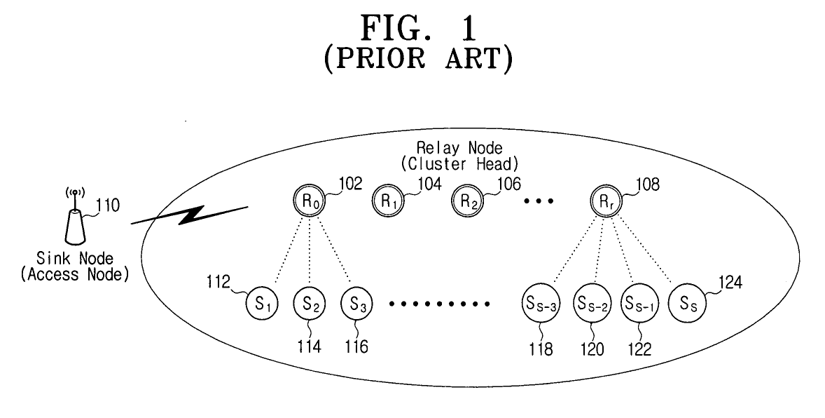

FIG. 2 is a schematic view showing the configuration of a wireless sensor network adopting an emergent data processing method according to an exemplary embodiment of the present invention;

FIG. 3 is a view showing the configuration of a wireless sensor network adopting emergent data processing method according to an exemplary embodiment of the present invention; and

FIG. 4 is a flow chart showing a method of processing emergent data in a wireless sensor network according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

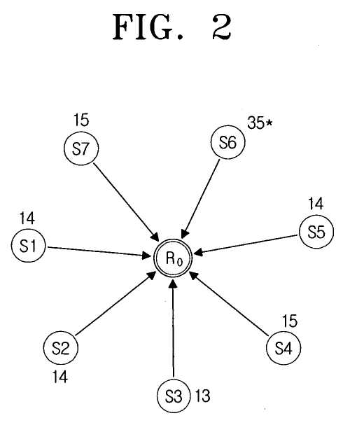

FIG. 2 is a schematic view showing the configuration of a wireless sensor network adopting an emergent data processing method according to an exemplary embodiment of the present invention.

In a wireless sensor network adopting a dynamic emergent data processing method according to an exemplary embodiment of the present invention, a relay node R0 receives and stores each sensing data from neighbor sensor nodes S1˜S7. When the relay node R0 receives sensing data having an emergency sign from one sensor node, for example, the sixth sensor node S6, if the sensing data is over a certain error compared to the latest data from neighbor sensor nodes, the sensing data are determined as emergent data. As a result, the emergent data are transmitted first as urgent data to a sink node 110, or when data received from the neighbor sensor nodes are aggregated, the sensing data from the sixth sensor node S6 are excluded and the aggregated data are transmitted to the sink node 110.

For example, in FIG. 2, values of other sensor nodes are mostly 14 or 15, but the value of the sixth sensor node S6 is 35. If the error of the sixth sensor node S6 is over ‘1’ of the preset error range, the sensing data from the sixth sensor node S6 are determined as emergent data.

Therefore, the dynamic emergent data processing method according to an exemplary embodiment of the present invention is used to check and manage if neighbor sensor nodes are normal.

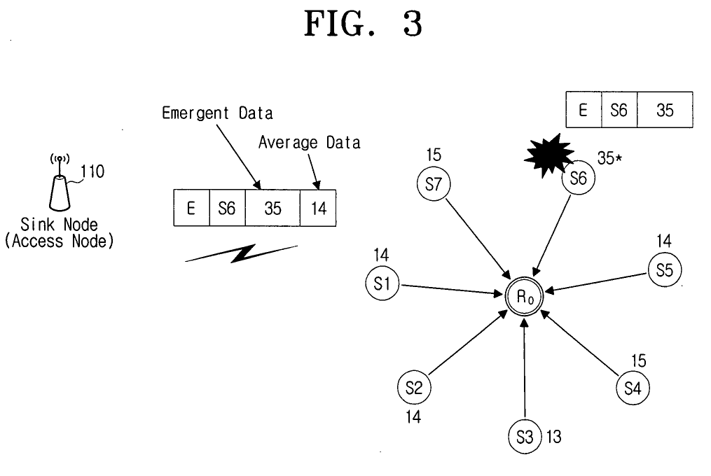

FIG. 3 is a view showing the configuration of a wireless sensor network adopting an emergent data processing method according to an exemplary embodiment of the present invention.

A wireless sensor network according to an exemplary embodiment of the present invention adopts a hybrid emergent data processing method. That is, when the first sensor node S1 to the seventh sensor node S7 transmit each sensing data to the relay node R0, sensing data over the threshold are generated from the sixth sensor node S6 as shown in FIG. 3 and are transmitted as urgent data to the relay node R0. Subsequently, the relay node R0 receives the sensing data from the first sensor node S1 to the seventh sensor node S7 and compares each sensing data. As shown in FIG. 3, if the sensing data from the sixth sensor node S6 are emergent data with a different value from sensing data received from other sensor nodes, the emergent data are added with the average data value of other sensing data, for example, 14, and transmitted to the sink node 110 of an access node.

The hybrid emergent data processing method according to an exemplary embodiment of the present invention double-checks the emergent data. First, whether data is emergent data is determined by sensing data transmitted from a sensor node where urgent data are generated. Secondly, sensing data received from each sensor node are compared. If the error is over a certain error range, the data is determined as emergent data.

Therefore, the hybrid emergent data processing method according to an exemplary embodiment of the present invention is used when emergencies such as intrusion or a fire have to be processed and when neighbor nodes have to be compared with each other on security monitoring.

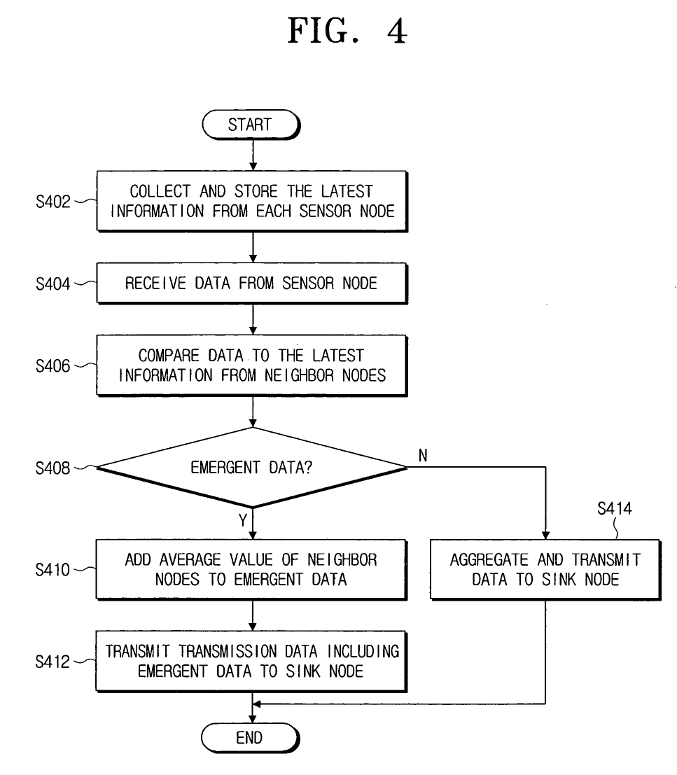

FIG. 4 is a flow chart showing a method of processing emergent data in a wireless sensor network according to an exemplary embodiment of the present invention.

First, a relay node 102 collects and stores the latest information, that is, sensing data from plural sensor nodes 112˜116 (S402). For example, as shown in FIG. 2 and FIG. 3, the relay node 102 receives and stores a sensing data value of 14 from the first sensor node S1, a sensing data value of 14 from the second sensor node S2, a sensing data value of 13 from the third sensor node S3 and a sensing data value of 15 from the forth sensor node S4.

Subsequently, if the relay node 102 receives a sensing data value of 35 from a certain sensor node, for example, the sixth sensor node S6 as shown in FIG. 3 (S404), the relay node 102 compares the sensing data value from the sixth sensor node S6 with the stored latest information from neighbor sensor nodes, that is, the sensing data values (S406).

The relay node 102 then calculates and stores the average value of the sensing data values, for example, 14. Accordingly, the error of the sensing data values of the neighbor sensor nodes is mostly 1.

When comparing the sensing data value from the sixth sensor node S6 and the sensing data values of the neighbor sensor nodes, if the error is over the preset error range, that is, 1, the relay node 102 determines the corresponding sensing data as emergent data (S408).

Accordingly, when the sensing data from the sixth sensor node S6 are determined as emergent data, the relay node 102 adds 14 of the average value of the neighbor sensing data values to the sensing data from the sixth sensor node S6, that is, to the sensing data of the emergent data as shown in FIG. 3 (S410). Herein, the emergent data includes urgent data and error data.

Next, the relay node 102 transmits the transmission data including the emergent data and the added data to a sink node 110, which is an access node connected to a communications network such as the internet (S412). This is an example of the hybrid emergent data processing method.

Therefore, the transmission data are transmitted to the communication network such as the internet through the sink node 110 and a user can receive the sensing service such as intrusion, a fire, and security, through a terminal device connected to the communications network.

In the dynamic emergent data processing method, the relay node 102 transmits as emergent data the sensing data received from the sixth sensor node S6 prior to sensing data received from neighbor sensor nodes to the sink node 110, or aggregates sensing data of the remaining sensor nodes, except the sensing data of the sixth sensor node S6, and transmits the aggregated data to the sink node 110.

As described above, the exemplary embodiments of the present invention implements a method of processing emergent data in a wireless sensor network in which the latest information is collected from each sensor node and stored, newly-received sensing data are determined as emergent data, if an error is over a certain value that is compared to the latest information from each node, and the emergent data are added with average data of neighbor nodes and transmitted to a sink node.

As can be appreciated from the above description, whether neighbor sensor nodes are normal in a wireless sensor network can be determined and managed. An intermediate node can process emergent data generated from each sensor node and separate data by a sensor malfunction or urgent data. Thus, a malfunction of each sensor node can be easily determined and reliability of sensing data of each sensor node can be improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of processing emergent data in a wireless sensor network, comprising:
collecting and storing latest data from sensor nodes;
receiving sensing data from a certain sensor node;
comparing the sensing data to the latest data; and
processing the sensing data into emergent data, if an error between the sensing data and the latest data is over a certain error range.

2. The method of claim 1, wherein the comparing of the sensing data is performed to check if neighbor sensor nodes are normal.

3. The method of claim 1, wherein the emergent data are first transmitted as urgent data to a sink node in the processing of the sensing data.

4. The method of claim 1, wherein sensing data received from the sensor nodes, except the emergent data, are aggregated and transmitted to the sink node in the processing of the sensing data.

5. The method of claim 1, wherein the emergent data comprises at least one of urgent data and error data.

6. A method of processing emergent data in a wireless sensor network, comprising:
receiving first sensing data from a sensor node where emergent data over a threshold are generated;
receiving second sensing data from at least one sensor node;
comparing the first sensing data to the second sensing data;
recognizing the first sensing data as the emergent data if an error between the first sensing data and the second sensing data is over a certain error range;
adding average data of the at least one sensor node to the emergent data; and
transmitting the added data to a sink node.

7. The method of claim 6, wherein the recognizing of the first sensing data is performed in an emergency comprising at least one of an intrusion and a fire.

8. The method of claim 6, wherein the recognizing of the first sensing data is performed when the first sensing data is compared to state data of the at least one sensor node.

9. The method of claim 6, wherein the emergent data comprises at least one urgent data and error data.
